(19) United States
(12) Patent Application Publication
(10) Pub. No.: US 2009/0297701 A1
(43) Pub. Date: Dec. 3, 2009

(54) Process for Repairing a Component with a Directional Microstructure

(75) Inventors: Rene Jabado, Berlin (DE); Jens Dahl Jensen, Berlin (DE); Ursus Krüger, Berlin (DE); Daniel Körtvelyessy, Berlin (DE); Michael Ott, Mulheim an der Ruhr (DE); Ralph Reiche, Berlin (DE); Michael Rindler, Schoneiche (DE); Rolf Wilkenhöner, Kleinmachnow (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT, Munchen (DE)

(21) Appl. No.: 12/083,035

(22) PCT Filed: Sep. 27, 2006
(86) PCT No.: PCT/EP2006/066779

§ 371 Date: Jul. 16, 2009

(30) Foreign Application Priority Data
Oct. 7, 2005 (EP) 05021898.1

(51) Int. Cl. B32B 43/00; B05D 1/12

(52) U.S. Cl. 427/142; 427/140

(57) ABSTRACT

A method of repairing a component, in particular a gas turbine component, which is produced from a base material with an oriented microstructure, comprises the steps of: cleaning the repair site, filling the repair site with a filling material corresponding to the composition of the base material, carrying out a heat treatment in the region of the filled repair site, wherein the filling material has micro- and/or nano-scale particles, during the filling of the repair site measures which prevent the oxidation of the filling material are taken, an the temperatures and holding times of the heat treatment are set appropriately for the composition of the filling material and of the base material of the component in such a way that an epitaxial attachment of the filling material to the surrounding bas material takes place.

### CROSS REFERENCE TO RELATED APPLICATIONS

This application is the US National Stage of International Application No. PCT/EP2006/066779, filed Sep. 27, 2006 and claims the benefit thereof. The International Application claims the benefits of European application No. 05021898.1 filed Oct. 7, 2005, both of the applications are incorporated by reference herein in their entirety.

### FIELD OF INVENTION

The present invention relates to a process for repairing a component, in particular a gas turbine component, which is made from a base material with a directional microstructure.

### BACKGROUND OF THE INVENTION

Machine components which in operation are exposed to high stresses, for example turbine components, are nowadays produced inter alia from highly heat-resistant superalloys, and in particular from those with a directional microstructure. These materials are distinguished by a high ability to withstand thermal and mechanical stresses. In this context, the term materials with a directional microstructure is to be understood in particular as meaning single-crystal materials and materials which have a grain structure in which the extent of the grains has a common preferential direction. Components having the grain structure described are known as directionally solidified components. Single-crystal materials are also known as SX materials, and directionally solidified materials are also known as DX materials.

When the components are subjected, in operation, to high thermal and mechanical stresses, material fatigue and, as a result, cracks can occur despite the use of the superalloy and even in the presence of a directional microstructure. Since it is expensive to produce components from superalloys, in particular with a directional microstructure, the general aim is to repair components with cracks. In so doing, it should be ensured that the repaired component can sufficiently withstand the thermal and mechanical stresses in further use.

One conventional process for repairing damaged components is soldering. During this soldering, a solder is applied to the material of the component in the region of the crack and joins to the base material by means of the action of heat. After the soldering, however, the solder material does not have a single-crystal or directionally solidified structure. However, a non-directional microstructure has worse materials properties—in particular in the high-temperature range—than a directional microstructure, and consequently the soldering site constitutes a weak point in the component. Welding processes are available for repairing damaged components with a directional microstructure, and can be used to create a directional microstructure in the welded zones as well. An example of a process of this type is disclosed in EP0 892 090 A1.

EP 1 666 635 A1 discloses a process, for repairing components made from a superalloy. A repair material is applied by cold spraying and this material, on coming into contact with the surface, is plastically deformed and bonded to the surface of the superalloy.

Further processes and solder powders that can be used are known from U.S. Pat. No. 6,283,356, U.S. Pat. No. 4,705,203, U.S. Pat. No. 4,900,394, U.S. Pat. No. 6,565,678, U.S. Pat. No. 4,830,934, U.S. Pat. No. 4,878,953, U.S. Pat. No. 5,666,643, U.S. Pat. No. 6,454,885, U.S. Pat. No. 6,503,349, U.S. Pat. No. 5,523,170, U.S. Pat. No. 4,878,953, U.S. Pat. No. 4,987,736, U.S. Pat. No. 5,806,751, U.S. Pat. No. 5,783,318, U.S. Pat. No. 5,873,703.

The development of soldering applications for components made from directional materials, in particular from single-crystal materials, inherently conceals the risk of recrystallization during the heat treatment, since the soldering application requires a temperature close to the melting point of the directional material.

In recent years, therefore, directional materials and in particular single-crystal materials have generally been repaired by welding applications, for example by means of a laser. Here, one important requirement is that the grain orientation be maintained, so that it is impossible for any weak points to be formed. Moreover, all welding applications introduce locally large quantities of heat into the material and therefore, on account of the temperature gradient which forms, lead to stresses in the material. These stresses can even lead to cracks, which negates the effect of the repair.

However, even if components are made from superalloys which do not have a directional microstructure, it is not always readily possible to carry out the repair by means of welding or soldering processes. For example, superalloys based on nickel and cobalt, which are often used as base materials for turbine blades or vanes, are susceptible to hot cracking. Hot cracks occur during welding in the heat-affected zone of the welding process and also in the weld metal itself if a material of a similar type to the base material is used as weld metal. Moreover, γ′-hardened superalloys are susceptible to the formation of cracks in the first heat treatment after welding (a phenomenon known as post-weld heat treatment cracking or strain age cracking). The cause of this is the inhomogeneous formation of the γ′ phase (ranging from dissolved to coarse-grained with all stages in between possible) in the heat-affected zone and—if filler of a similar type to the base material is used as weld metal—in the weld metal itself. During the first heat treatment, the γ′ phase is then locally precipitated, with an associated volume contraction and build-up of residual stresses, consequently leading to crack formation. Furthermore, the local heating during welding leads to the build-up of high residual stresses in the material. Finally, the welding metallurgy (e.g. rapid solidification and mixing of base material and filler) can lead to undesirable effects, for example the formation of brittle phases or segregations, i.e. separation of the melt, in the weld metal. All the effects mentioned have an adverse effect on the mechanical properties of a component repaired by means of a welding process. Moreover, if γ′-hardened fillers (e.g. Nimonic C263, Rene 41, Haynes 282) are used, prolonged overaging prior to the welding is generally required in order to increase the weldability of the base material. This makes the welding repair more expensive.

In soldering processes used to repair components, the soldering alloys generally contain elements that reduce the melting point. These are often boron (B), which can lead to the formation of brittle phases during a heat treatment and subsequent operation of the component under the action of hot gases. The brittle phases have an adverse effect on the mechanical properties of the repair site. Moreover, for example, soldering repairs for gas turbine blades or vanes are lengthy processes, in some cases lasting more than 24 h and requiring a multi-stage heat treatment. This significantly increases the repair costs. Furthermore, the high-temperature heat treatments which are required for soldering repairs can lead to recrystallization in the case of directionally solidified materials or single-crystal materials. However, recrystallization is generally unacceptable, and consequently soldering repairs are often not viable for materials of this type.

### SUMMARY OF INVENTION

Proceeding from the abovementioned prior art, it is a first object of the present invention to provide an improved process for repairing a component made from a base material with a directional microstructure, in particular a turbine component.

A second object of the present invention is to provide an improved process for repairing a component, in particular a turbine component, made from a highly heat-resistant superalloy.

The first object is achieved by the process for repairing a component as claimed in the claims and the second object by the process for repairing a component as claimed in the claims. The dependent claims give advantageous configurations of the invention.

The process according to the invention for repairing a component which is made from a base material with a directional microstructure comprises, according to the claims, the steps of: cleaning the repair site, filling the repair site with a filling material that corresponds to the composition of the base material, and carrying out a heat treatment in the region of the filled repair site. The component that is to be repaired may in particular be a gas turbine component, for example a turbine blade or vane. In the process according to the invention, the filling material includes micro-scale and/or nanoscale particles. Moreover, during the filling of the repair site measures are taken to prevent the oxidation of the filling material. Finally, the temperatures and holding times of the heat treatment are selected in such a manner that the repair site has the same directional microstructure as the base material surrounding the repair site. The directional microstructure can be realized in particular by the temperature of the heat treatment being below the melting temperature of the base material and the cooling not exceeding a certain cooling rate. An excessively high cooling rate would disrupt the ordered growth and therefore the formation of a directional microstructure in the repair site. The temperatures and cooling rates to be adopted are in each case dependent on the base material, and consequently may differ for different base materials. Suitable cooling rates can in particular be determined empirically.

The process according to the invention can be used to structurally repair cracks in components made from directionally solidified materials, in such a manner that the repair site has the same directional microstructure and without the properties of the surrounding base material being adversely affected. The use of micro-scale and/or nanoscale particles means that the melting temperature of the filling material is lower than the melting temperature of the surrounding base material. The heat treatment can therefore be carried out at temperatures which are lower than the temperatures used in a soldering process. Also, the quantities of heat produced locally are not as high as in the welding process described in the introduction.

A spraying process can be used to fill the repair site, allowing a low temperature to be used for the sprayed particles. By way of example, it is conceivable to use a low-temperature high-velocity flame spraying process, as described for example in DE 102 53 794 A1. However, it is preferable to use a cold spraying process, as described for example in DE 102 24 780 A1, to fill the repair site. If low-temperature flame spraying is used, it is possible to largely suppress the oxidation of the sprayed particles. Cold spraying, in which spray particles are accelerated to high velocities by a ‘cold’ gas jet, allows the oxidation to be prevented to an even greater extent, so that there is virtually no oxidation of the sprayed particles.

Since particles with diameters of less than approx. 5 μm cannot easily be sprayed directly by means of cold spraying processes, in an advantageous configuration of the invention the particles for filling the repair site are surrounded by a shell. The shell, which may be composed of a material constituent of the base material, for example nickel or cobalt, increases the size of the particles. On account of the increased size, the particles can be better entrained and accelerated by the cold-gas stream. The kinetic energy, which is converted into heat on impact with the walls of the filling site, leads to partial melting of the filling material. In order to protect the regions surrounding the repair site during spraying, these regions can be covered with a diaphragm during filling.

In an advantageous configuration of the process according to the invention, the filling material is in the form of at least two constituents with a eutectic mixing ratio. A eutectic mixing ratio is a mixing ratio which has the effect that only solid solutions are formed from a melt of the material composition during cooling. By contrast, a mixing ratio that deviates from the eutectic leads to the formation of pure crystals of both material constituents during cooling. Moreover, the eutectic mixing ratio is distinguished by the fact that it has the lowest melting temperature of all the mixing ratios of the two material constituents. In the process according to the invention, this has the particular advantage that the heat treatment can be carried out at particularly low temperatures.

The cleaning process prior to the filling of the repair site should preferably be carried out in such a manner that any oxides that are present are completely removed from the site that is to be repaired.

The process according to the invention can be used in particular to fill the crack ends when repairing cracks in the base material of a component. It is not readily possible to fill the crack ends with larger particles. However, it is very important to fill the crack ends, since by repairing in particular the crack ends it is possible to effectively prevent crack propagation. The bulk volume of the cracks can then if appropriate also be filled using particles that are larger than the micro-scale and/or nanoscale particles.

In the process according to the invention for repairing a component which is made from a highly heat-resistant superalloy, in accordance with the claims a repair material is applied by the repair material in the form of powder particles being sprayed by cold spraying. The repair material in this case has a higher ductility than the highly heat-resistant superalloy.

Proposed repair materials are materials that are more ductile than the base material. These may in particular be materials which are already used for repairs—in particular welding repairs—or may alternatively be γ′-hardened superalloys. The latter represent a good compromise between reduced strength and improved weldability compared to the base material. Other repair materials that can be used are Ni superalloys which are considered as wrought alloys, since they have a significantly higher ductility than the Ni cast superalloys which are currently used for gas turbine blades or vanes. It is also possible for the repair materials used to be materials that are currently used for soldering repairs. However, it is possible to dispense with the addition or alloying of elements that reduce the melting point, since the filler is not melted during the cold gas repair.

The repair of in particular gas turbine blades or vanes made from Ni or Co superalloys by means of cold spraying has the following advantages over conventional welding and soldering repairs:

The additional material used as repair material is applied cold. The pulverulent filler is only warmed but not melted in the preheated gas stream. The component itself remains cold. Consequently, there is no hot cracking.

There is no heat-affected zone. The γ′ phase in the base material is neither dissolved nor coarsened. Therefore, it is impossible for any strain age cracking to occur in the base material. The risk of cracks of this type forming in the weld metal if γ′-hardened fillers are used is likewise significantly reduced.

The material is not melted. Consequently, there are no undesirable metallurgical reactions, for example brittle phase formation and segregation during welding or the formation of embrittling borides during soldering.

There is no need for lengthy heat treatments as in the case of soldering and welding (if overaging is required). Fewer and shorter heat treatments result in reduced repair costs. After the cold spraying repair, all that is required is a bonding heat treatment (for example 1000-1100° C. for 10 min to 2 h). The component may then have to be completely heat treated (solution annealing and age hardening), but this is generally also required after welding and soldering repairs.

The risk of oxidation of the repair site is low. A shielding gas stream (usually helium, possibly nitrogen) is used, and the component (generally <300° C.) and the filler (generally <500 up to 700° C.) remain at relatively low temperatures. The residual oxygen content (about 400 ppm O₂ or less) is lower than in other spraying processes, such as for example HVOF. Consequently, only small quantities of disruptive oxidic foreign phases, which could lead to embrittlement of the repair sites, are formed.

Cold-sprayed surfaces are generally very smooth. The diameter of the cold-sprayed powder jet is very fine. Consequently, the repaired sites require only a very small amount of re-machining, which reduces repair costs.

Repairs carried out using materials of a similar composition to the base material have the potential for the properties of the repair site to correspond to those of the base material. However, the Ni superalloys which are used commercially (e.g. Rene80, IN738LC, IN393, CM247CC/DS, IN939, PWA1483SX, SEEMET DS . . . ) are extremely hard and brittle. These properties are detrimental to the ability of these materials to be processed using cold spraying.

Consequently, the use of more ductile fillers for repairing gas turbine blades or vanes made from Ni superalloys offers the following advantages compared to repairs using materials of a similar composition to the base material (albeit with a reduced strength of the filler):

It is possible to apply denser, better-bonding layers by cold spraying.

The powder efficiency (generally approximately between 15 and 35%) is increased, which is of benefit to the economic viability of the process.

It is possible to spray at lower particle velocities, which is of benefit to the process economics. By way of example, it would be possible to use larger nozzle diameters, with an associated increased coating rate. The particle velocities may be less than approx. 900 m/s and in particular less than 800 m/s.

When spraying the repair material, the site that is to be repaired can be masked out. In other words, material is removed in the region of the repair site, so as to form a cavity that is simple to fill where the damage was located. The missing material can then be applied by means of cold spraying. Alternatively, it is possible for damage, for example cracks, to be filled directly by means of cold spraying. In this case, it is advantageous if the repair site is first of all cleaned, for example by fluoride ion cleaning, in order to remove surface impurities, such as oxides. Impurities of this type would adversely affect the bonding between the base materials and the repair material. Although it is possible that not all of the crack will be filled in the event of direct filling of cracks, but rather the crack is only covered over, this may under certain circumstances be acceptable.

In the process according to the invention, the powder material used may in particular be a material which contains nanoscale powder particles that are surrounded by a shell of nanoscale particles.

### BRIEF DESCRIPTION OF THE DRAWINGS

Further features, properties and advantages of the present invention will emerge from the following description of an exemplary embodiment with reference to the accompanying figures, in which:

FIG. 1 shows an example of a partial longitudinal section through a gas turbine,

FIG. 2 shows a perspective view of a rotor blade or guide vane of a turbomachine,

FIG. 3 shows a combustion chamber of a gas turbine,

FIG. 4 diagrammatically depicts an excerpt from a turbine blade or vane with a crack,

FIG. 5 diagrammatically depicts the crack in a sectional side view,

FIG. 6 shows the filling of the crack from FIG. 5,

FIG. 7 shows the filled crack after a heat treatment has been carried out,

FIG. 8 shows an agglomerate of particles as used to fill the crack,

FIGS. 9 to 11 show a further exemplary embodiment of the process according to the invention for repairing a component,

FIGS. 12 to 14 show a third exemplary embodiment of the process according to the invention for repairing a component.

### DETAILED DESCRIPTION OF INVENTION

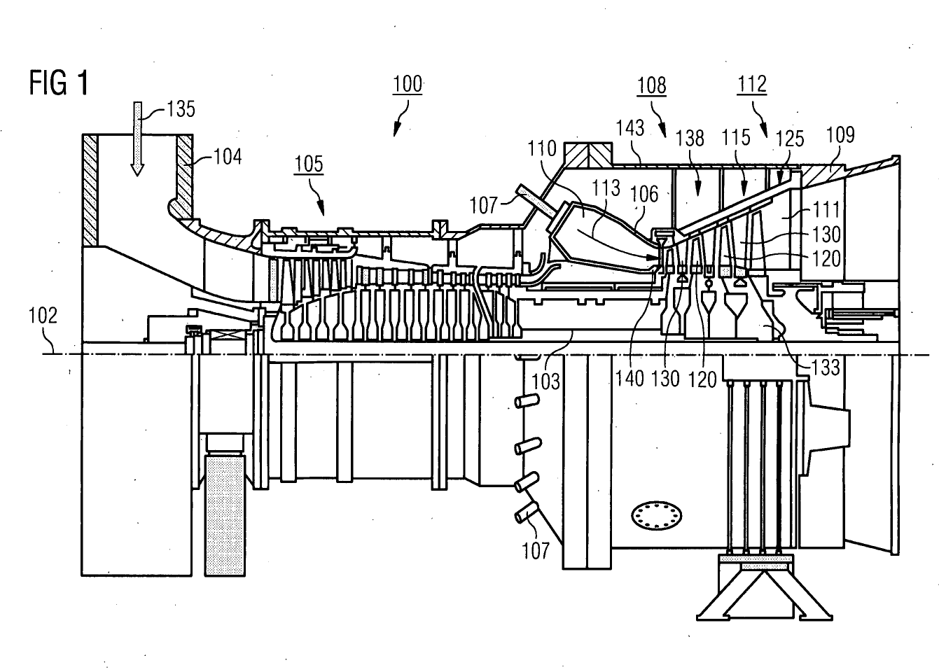

FIG. 1 shows, by way of example, a partial longitudinal section through a gas turbine 100. In the interior, the gas turbine 100 has a rotor 103 which is mounted such that it can rotate about an axis of rotation 102 and is also referred to as the turbine rotor. An intake housing 104, a compressor 105, a, for example, toroidal combustion chamber 110, in particular an annular combustion chamber 106, with a plurality of coaxially arranged burners 107, a turbine 108 and the exhaust-gas housing 109 follow one another along the rotor 103.

The annular combustion chamber 106 is in communication with a, for example, annular hot-gas passage 111, where, by way of example, four successive turbine stages 112 form the turbine 108.

Each turbine stage 112 is formed, for example, from two blade or vane rings. As seen in the direction of flow of a working medium 113, in the hot-gas passage 111 a row of guide vanes 115 is followed by a row 125 formed from rotor blades 120.

The guide vanes 130 are secured to an inner housing 138 of a stator 143, whereas the rotor blades 120 of a row 125 are fitted to the rotor 103 for example by means of a turbine disk 133.

A generator (not shown) is coupled to the rotor 103.

While the gas turbine 100 is operating, the compressor 105 sucks in air 135 through the intake housing 104 and compresses it. The compressed air provided at the turbine-side end of the compressor 105 is passed to the burners 107, where it is mixed with a fuel. The mix is then burnt in the combustion chamber 110, forming the working medium 113. From there, the working medium 113 flows along the hot-gas passage 111 past the guide vanes 130 and the rotor blades 120. The working medium 113 is expanded at the rotor blades 120, transferring its momentum, so that the rotor blades 120 drive the rotor 103 and the latter in turn drives the generator coupled to it.

While the gas turbine 100 is operating, the components which are exposed to the hot working medium 113 are subject to thermal stresses. The guide vanes 130 and rotor blades 120 of the first turbine stage 112, as seen in the direction of flow of the working medium 113, together with the heat shield elements which line the annular combustion chamber 110, are subject to the highest thermal stresses.

To be able to withstand the temperatures which prevail there, they have to be cooled by means of a coolant.

Substrates of the components may likewise have a directional structure, i.e. they are in single-crystal form (SX structure) or have only longitudinally oriented grains (DS structure).

By way of example, iron-base, nickel-base or cobalt-base superalloys are used as material for the components, in particular for the turbine blade or vane 120, 130 and components of the combustion chamber 110. Superalloys of this type are known, for example, from EP 1 204 776 B1, EP 1 306 454, EP 1 319 729 A1, WO 99/67435 or WO 00/44949; these documents form part of the disclosure.

The blades or vanes 120, 130 may also have coatings which protect against corrosion (MCrAlX; M is at least one element selected from the group consisting of iron (Fe), cobalt (Co), nickel (Ni), X is an active element and represents yttrium (Y) and/or silicon and/or at least one rare earth element or hafnium). Alloys of this type are known from EP 0 486 489 B1, EP 0 786 017 B1, EP 0 412 397 B1 or EP 1 306 454 A1, which are intended to form part of the present disclosure.

A thermal barrier coating, consisting for example of ZrO₂, Y₂O₃—ZrO₂, i.e. unstabilized, partially stabilized or completely stabilized by yttrium oxide and/or calcium oxide and/or magnesium oxide, may also be present on the MCrAlX. Columnar grains are produced in the thermal barrier coating by suitable coating processes, such as for example electron beam physical vapor deposition (EB-PVD).

The guide vane 130 has a guide vane root (not shown here), which faces the inner housing 138 of the turbine 108, and a guide vane head which is at the opposite end from the guide vane root. The guide vane head faces the rotor 103 and is fixed to a securing ring 140 of the stator 143.

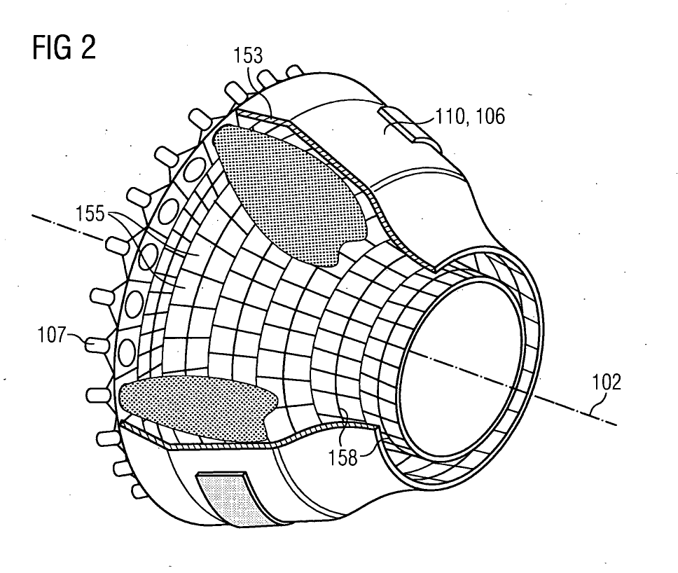

FIG. 2 shows a perspective view of a rotor blade 120 or guide vane 130 of a turbomachine, which extends along a longitudinal axis 121.

The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406.

As a guide vane 130, the vane 130 may have a further platform (not shown) at its vane tip 415.

A blade or vane root 183, which is used to secure the rotor blades 120, 130 to a shaft or a disk (not shown), is formed in the securing region 400.

The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade or vane 120, 130. Superalloys of this type are known, for example, from EP 1 204 776 B1, EP 1 306 454, EP 1 319 729 A1, WO 99/67435 or WO 00/44949; these documents form part of the disclosure. The blade or vane 120, 130 is in this case produced by a casting process or by means of directional solidification, by a forging process, by a milling process or by a combination of these.

Workpieces with a single-crystal structure or structures are used as components for machines which, in operation, are exposed to high mechanical, thermal and/or chemical stresses. Single-crystal workpieces of this type are produced, for example, by directional solidification from the melt. This involves casting processes in which the liquid metallic alloy solidifies to form the single-crystal structure, i.e. the single-crystal workpiece, or solidifies directionally. In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal component. Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures). Processes of this type are known from U.S. Pat. No. 6,024,792 and EP 0 892 090 A1; these documents form part of the disclosure.

The blades or vanes 120, 130 may likewise have coatings protecting against corrosion or oxidation (MCrAlX; M is at least one element selected from the group consisting of iron (Fe), cobalt (Co), nickel (Ni), X is an active element and represents yttrium (Y) and/or silicon and/or at least one rare earth element, or hafnium (Hf)). Alloys of this type are known from EP 0 486 489 B1, EP 0 786 017 B1, EP 0 412 397 B1 or EP 1 306 454 A1, which are intended to form part of the present disclosure.

It is also possible for a thermal barrier coating, consisting for example of ZrO₂, Y₂O₃.ZrO₂, i.e. unstabilized, partially stabilized or completely stabilized by yttrium oxide and/or calcium oxide and/or magnesium oxide, to be present on the MCrAlX. Columnar grains are produced in the thermal barrier coating by means of suitable coating processes, such as for example electron beam physical vapor deposition (EB-PVD).

Refurbishment means that after they have been used, protective layers may have to be removed from components 120, 130 (e.g. by sand-blasting). Then, the corrosion and/or oxidation layers and products are removed. If appropriate, cracks in the component 120, 130 are also repaired. This is followed by recoating of the component 120, 130, after which the component 120, 130 can be reused.

The blade or vane 120, 130 may be hollow or solid in form. If the blade or vane 120, 130 is to be cooled, it is hollow and may also have film-cooling holes 418 (indicated by dashed lines).

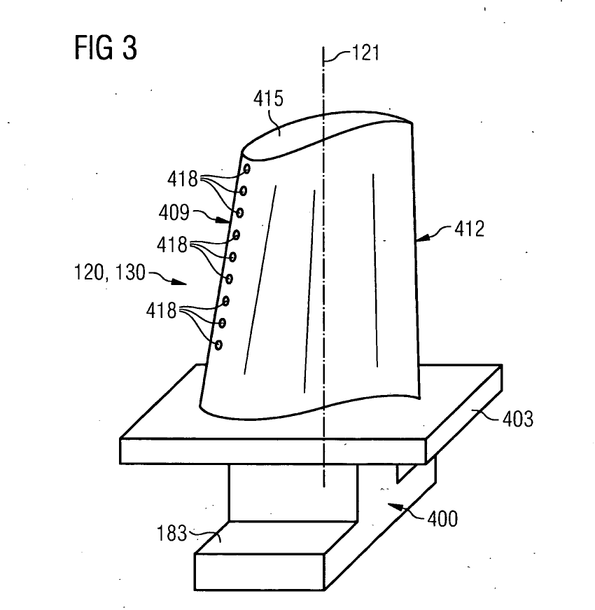

FIG. 3 shows a combustion chamber 110 of a gas turbine. The combustion chamber 110 is configured, for example, as what is known as an annular combustion chamber, in which a multiplicity of burners 107 arranged circumferentially around the axis of rotation 102 open out into a common combustion chamber space. For this purpose, the combustion chamber 110 overall is of annular configuration positioned around the axis of rotation 102.

To achieve a relatively high efficiency, the combustion chamber 110 is designed for a relatively high temperature of the working medium M of approximately 1000° C. to 1600° C. To allow a relatively long service life even with these operating parameters, which are unfavorable for the materials, the combustion chamber wall 153 is provided, on its side which faces the working medium M, with an inner lining formed from heat shield elements 155.

On the working medium side, each heat shield element 155 is provided with a particularly heat-resistant protective layer or is made from material that is able to withstand high temperatures. These may be solid ceramic bricks or alloys with MCrAlX and/or ceramic coatings. The materials of the combustion chamber wall and its coatings may be similar to the turbine blades or vanes.

Moreover, on account of the high temperatures in the interior of the combustion chamber 110, a cooling system may be provided or the heat shield elements 155 and/or for their holding elements.

The combustion chamber 110 is designed in particular to detect losses of the heat shield elements 155. For this purpose, a number of temperature sensors 158 are positioned between the combustion chamber wall 153 and the heat shield elements 155.

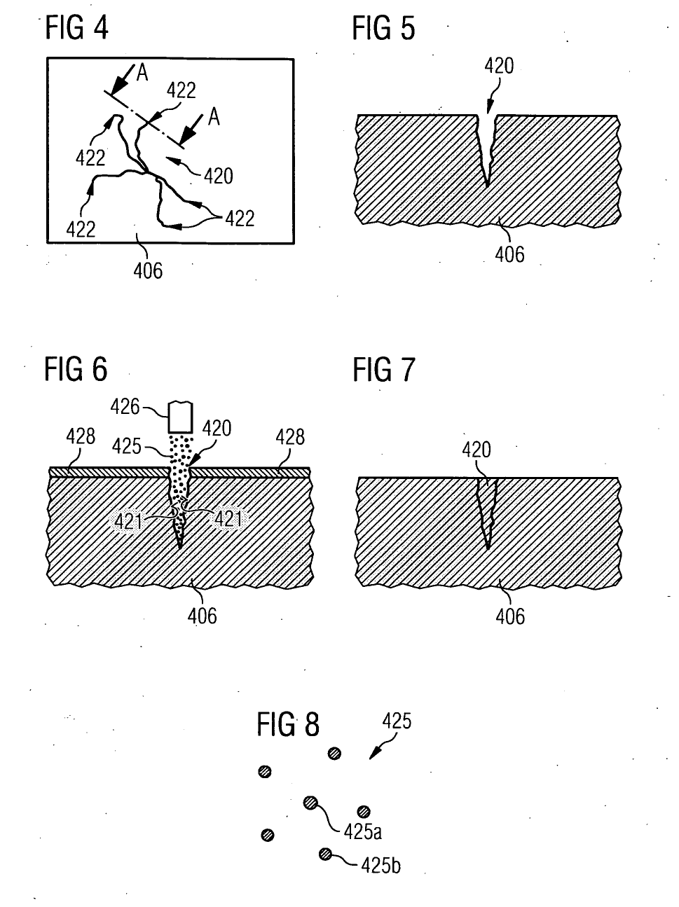

FIG. 4 shows a highly diagrammatic view of an excerpt from the main blade or vane part 406 with a branched crack 420. The main blade or vane part 406 is made from a single-crystal nickel-based alloy. In principle, however, it is also possible to use the process according to the invention to repair components made from other single-crystal base alloys, for example cobalt-based alloys or iron-based alloys. The crack 420 has a number of crack ends 422, in the vicinity of which there are particularly high stresses in the single-crystal base material. The stresses can lead to further propagation of the crack 420. It is therefore particularly important to prevent crack propagation in the region of the crack ends 422.

The turbine main blade or vane part 406 can be repaired by filling the crack 420 with a material of a similar type to the base material and by then joining this material to the base material using a suitable heat treatment. In particular if this is done in the region of the crack ends 422, further crack propagation is effectively suppressed and the repaired turbine main blade or vane part 406 can be returned to operation.

To enable the repaired turbine main blade or vane part 406 to withstand the high thermal and mechanical stresses when the turbine is operating, the filling of the crack 420 should have the same single-crystal structure as the surrounding base material. This can be achieved using the repair process described below.

FIG. 5 diagrammatically depicts a sectional view through the turbine main blade or vane part 406. The section runs along line A-A in FIG. 4. The figure shows the crack 420 prior to filling and after cleaning, during which all the oxides were removed from the crack walls. The crack cleaning can be carried out using conventional cleaning processes. Alternatively, it is possible to widen the crack 420 by means of a spark erosion pin.

The cleaned crack 420 is filled with a filling material of a similar type to the base material. The filling operation is illustrated diagrammatically in FIG. 6. In the present exemplary embodiment, as mentioned above, the base material is a nickel-based alloy containing, inter alia, aluminum as addition. The nanoscale particles which are sprayed into the crack 420 by means of a cold spray gun 426 can be used as filling material.

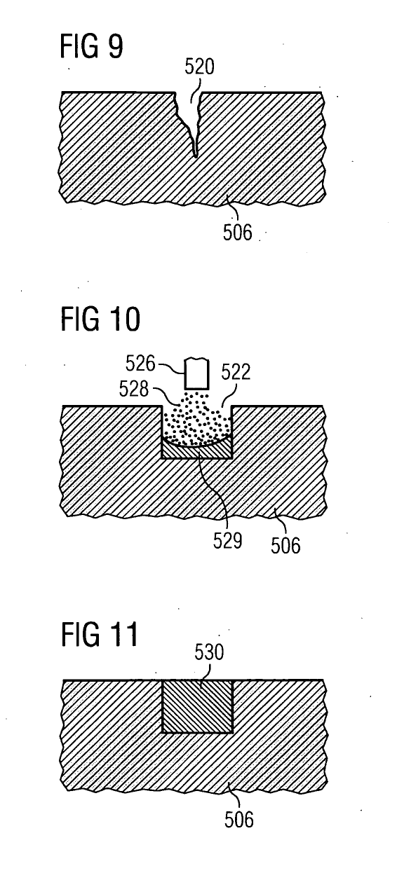

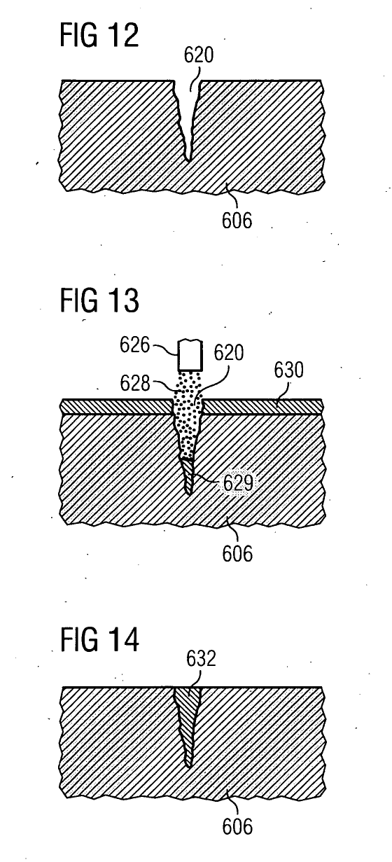

To enable the nanoscale particles, which have a particle size of less than 5 μm and preferably less than 1 μm, to be sprayed by means of the cold spraying process, they are combined with other particles to form agglomerates 425. The agglomerates then have the cross section required in order to be entrained by the cold-gas stream, for example a helium stream, in the direction of the crack 420. An agglomerate of this type is illustrated by way of example in FIG. 8. In the present exemplary embodiment, the agglomerate 425 comprises a central nanoscale aluminum particle 425a with nanoscale nickel particles 425b agglomerated around it. The agglomerate is held together by electrostatic forces. The nickel particles 425b form a shell around the aluminum particles 425a, with the result that the diameter of the agglomerate is at least 5 μm. The cross section of the agglomerate is then large enough to be entrained by the helium stream. When it strikes the crack wall 421, the agglomerate 425 breaks down into its constituents.

When filling the crack 420, the surface regions of the main blade or vane part 406 in which there is no crack 420 are covered by means of a mask 428 in order to ensure that no material is applied at these locations.

After the crack 420 has been completely filled with the nanoscale particles, a heat treatment is carried out, the temperatures and holding times of which are adapted to the base material in such a manner that the filling material is epitaxially bonded to the crack wall 421 and the required inter-diffusion of the particles of the filling material mixture takes place. On account of the small particle diameters, the melting point of the particles is reduced, so that the temperatures required during the heat treatment are below the melting point of the surrounding base material of the main blade or vane part 406. The cooling of the component is carried out sufficiently slowly to ensure that ordered growth of the crystal structure of the material in the repair site is not impeded.

In this way, epitaxial bonding of the filling material to the base material can take place at temperatures below the melting temperature of the base material of the main blade or vane part 406, so that the filling material continues the crystal structure of the surrounding base material. The result is the filled crack 420′ illustrated in FIG. 7, in which the filling material forms a single-crystal structure together with the surrounding base material.

In a particularly advantageous configuration of the process, the composition of the agglomerates 425, i.e. the ratio of the number of shell particles to a central particle, is selected in such a way that the filling material is in a eutectic mixture, with the result that as it resolidifies after melting during the heat treatment the filling material forms a solid solution. Moreover, the melting temperature of a eutectic mixture is the lowest possible melting temperature of the mixture compared to a mixture comprising the same constituents but in different mixing ratios. If the filling material contains the same constituents as the surrounding base material and is in a eutectic mixing ratio, therefore, its melting temperature is well below the melting temperature of the surrounding base material.

The process that has been outlined can be used in particular to fill the crack 420 in the region of the ends 422 in such a way that the single-crystal structure of the surrounding base material is continued. It is in this way possible to significantly reduce the stresses in the base material through the region of the crack ends 422, so that it is possible to effectively prevent propagation of the crack 420. The remaining regions of the crack can then be filled with particles that are coarser than nanoscale particles, which cannot readily be used to continue the single-crystal structure of the base material. It is particularly important in this context that the crack ends 422 can be reliably filled by means of the nanoscale particles.

FIG. 9 shows a highly diagrammatic sectional view through an excerpt from a main blade or vane part 506 with a crack 520. The main blade or vane part 506 is made from a nickel-based alloy with a polycrystalline crystal structure. However, it is in principle also possible to repair other base alloys, for example cobalt-based or iron-based alloys, using the process according to the invention. The component that is to be repaired may also have a single-crystal base material or a directionally solidified base material instead of a polycrystalline base material.

In a first step of the process, the crack is widened, for example by means of a spark erosion pin, during which contamination is also removed in the region of the crack wall. The widening forms a recess 522 in the component 506 where the crack 520 was located. This recess 522 is then filled with a repair material.

The filling of the recess 522 with the repair material is diagrammatically depicted in FIG. 10. In addition to the main blade or vane part 506 and the recess 522, the figure also shows the nozzle 526 of a cold spraying apparatus and repair material 529 which is sprayed into the recess 522 in the form of powder 528 by means of the cold spraying apparatus.

An appropriate repair material is a material that has a higher ductility than the base material of the main blade or vane part 506. In other words, under the action of external forces the repair material is subject to plastic and therefore permanent deformations without the material splitting in any way. Ductile materials in particular have good cold-forming properties. The repair material may in particular be a material that is used in the prior art for repairs using welding processes. Examples include nickel-based alloys with a high ductility and weldability, for example alloys known under the names IN 617, Haste Alloy X, Coat Metal CM64, PWA 795. Alternatively, it is also possible to use γ′-hardened superalloys as the repair material. Grains of γ′ phase in a γ phase which has a body centered cubic lattice structure are present in γ′-hardened superalloys. The grains of γ′ phase lead to hardening of the superalloy material. Examples of suitable γ′-hardened superalloys as coating material include materials known under the names Nimonic C263, Rene 41, Haynes 282. These constitute a good compromise between reduced strength and improved weldability compared to the base material. The improved weldability results from the higher ductility compared to the base material. Further alternatives of the materials that can be used for the repair include nickel superalloys considered wrought alloys since they have a significantly higher ductility than the cast nickel superalloys that are often used for gas turbine blades or vanes. Moreover, it is also possible to use repair materials as are currently used for soldering repairs. However, there is no need to add or alloy in elements which reduce the melting point (such as in particular boron (B), but also for example zirconium (Zr), hafnium (Hf), scandium (Sc), platinum (Pt) or palladium (Pd)), since the repair material is not melted during the cold spraying.

The powder 528 of repair material which is sprayed by means of the nozzle 526 is compacted through cold-forming when it strikes the surface of the recess 522. As a result of cold-forming and additional adhesion, the sprayed powder adheres to the surface of the recess 522. The more ductile the repair material used, the better these mechanisms function. Therefore, a dense layer with good adhesion is produced in the recess 522 with the aid of the cold spraying of ductile repair materials. The spraying of the powder 528 takes place in the preheated helium stream. The powder is only warmed but not melted therein. The component 506 itself remains cold, i.e. generally below 300° C., with the result that no hot cracks occur. The preheated helium may be at temperatures in the range from 500° C. to 700° C. As an alternative to helium, it is also possible to use another inert gas, for example nitrogen, for the cold spraying.

The particle velocities in the sprayed power material are approx. 900 m/sec or less, in particular less than approx. 800 m/s. On account of the relatively low particle velocities, it is possible to use nozzles 526 with relatively large nozzle diameters, which allows the coating rate to be increased compared to cold spraying processes for repairing turbine blades or vanes according to the prior art.

The main blade or vane part after the repair material has been sprayed on is illustrated in FIG. 11. The repair material which has been sprayed into the recess 522 forms a dense, securely attached insert 530 in the recess, which moreover has a smooth surface.

After the filling of the recess 522, i.e. in the state illustrated in FIG. 11, it is possible to carry out a heat treatment of the entire component, for example solution annealing.

A further exemplary embodiment of the process according to the invention for repairing a component is illustrated in FIGS. 12 to 14. FIG. 12 shows a main blade or vane part 606 having a crack 620 which corresponds to the main blade or vane part 506 from FIG. 9. Before the crack 620 is filled, the crack walls are cleaned in order to remove oxides. The crack cleaning can be carried out using conventional cleaning processes.

After the cleaning, the crack 620 is filled with a repair material that has a higher ductility than the base material of the main blade or vane part 606. The repair material is sprayed into the crack 620 in the form of a powder 628 by means of the nozzle 626 of a cold spraying apparatus. The surface of the component 606 has previously been covered by means of a mask 630 in the region outside the crack 620, in order to prevent the repair material from adhering in this region.

The statements made in connection with the process illustrated in exemplary embodiments 9 to 11 correspondingly also apply for the spray conditions and possible repair materials here.

After the repair material has been sprayed into the crack, it forms a dense insert 632 which is securely bonded to the base material of the main blade or vane part 606 and also has a smooth surface. Depending on the particle size of the powder 628 that is used, it is possible that not all the crack will be filled, but rather that the crack will merely be covered over. In other words, the powder may not penetrate into regions of the crack which have particularly small dimensions.

However, in some cases it is possible to tolerate the crack just being covered over in this way.

It is also possible for nanoscale particles to be sprayed as the repair material. Since particles of a size of less than 5 μm and preferably less than 1 μm cannot readily be sprayed by means of cold spraying processes, the particles can be sprayed in the form of agglomerates, as have been described with reference to FIG. 8. In this case, a central particle has a shell which surrounds the central particle, so that the agglomerate has a size of at least 5 μm. On striking the surface of the crack or repair material that is already within the crack, the agglomerates break up on account of the relatively weak bonding between the particles, with the result that the individual nanoscale particles are then present in separated form.

The composition of the agglomerates is selected in such a way that it corresponds to an alloy which has a higher ductility than the base alloy of the main blade or vane part 606. Of course, particle agglomerates of this type can also be sprayed by means of the cold spraying process in the exemplary embodiment that has been described with reference to FIGS. 9 to 11.

1.-17. (canceled)

18. A process for repairing a gas turbine component made from a base material with a directional microstructure, comprising:
cleaning the repair site;
filling the repair site with a filling material corresponding to the composition of the base material; and
carrying out a heat treatment in a region of the filled repair site;
wherein
the filling material includes micro-scale and/or nanoscale particles,
during the filling of the repair site measures are taken to prevent the oxidation of the filling material, and
the temperatures and holding times of the heat treatment are adapted to the composition of the filling material and of the base material of the component such that the filling material is epitaxially bonded to the surrounding base material.

19. The process as claimed in claim 18, wherein a spraying process is used for the filling of the repair site allowing a low temperature of the sprayed particles to be used.

20. The process as claimed in claim 19, wherein a cold spraying process is used for the filling of the repair site.

21. The process as claimed in claim 20, wherein the particles are surrounded by a shell during the filling of the repair site.

22. The process as claimed in claim 21, wherein the shell is formed from a constituent of the base material.

23. The process as claimed in claim 22, wherein a diaphragm that covers regions that are not to be filled is used during the filling of the repair site.

24. The process as claimed in claim 23, wherein the filling material includes a plurality of material constituents with a eutectic mixing ratio.

25. The process as claimed in claim 24, wherein the cleaning comprises removal of all the oxides from the repair site.

26. The process as claimed in claim 25, wherein the repair site is a crack in the base material, and the filling of the crack is carried out such that a crack end is filled with micro-scale or nanoscale particles.

27. A process for repairing a gas turbine component made from a highly heat-resistant superalloy, comprising:
providing a spray material in the form of powder particles having a higher ductility than the highly heat-resistant superalloy; and
applying the repair material onto a repair site by spraying the repair material onto the repair site via cold spraying.

28. The process as claimed in claim 27, wherein the repair material is a group with a γ′-hardened superalloy material.

29. The process as claimed in claim 27, wherein the repair material is a wrought alloy.

30. The process as claimed in claim 27, wherein the repair material is a soldering repair material.

31. The process as claimed in claim 30, wherein the velocity of the sprayed powder particles amounts to no more than 900 m/s.

32. The process as claimed in claim 31, wherein the repair site is screened out prior to the spraying of the repair material.

33. The process as claimed in claim 32, wherein the repair site is cleaned prior to the spraying of the repair material.

34. The process as claimed in claim 33, wherein nanoscale powder particles surrounded by a shell of nanoscale particles are used.
